(19) United States
(12) Patent Application Publication
(10) Pub. No.: US 2002/0193977 A1
(43) Pub. Date: Dec. 19, 2002

(54) Method and apparatus for simulating electronic circuits having conductor or dielectric losses

(76) Inventor: Richard A. Elco, Mechanicsburg, PA (US)

Correspondence Address: Roberts, Abokhair & Mardula, LLC, Suite 1000, 11800 Sunrise Valley Drive, Reston, VA, 20191, US

(21) Appl. No.: 10/117,734

(22) Filed: Apr. 5, 2002

Related U.S. Application Data
(60) Provisional application No. 60/281,572, filed on Apr. 5, 2001.

(51) Int. Cl. G06F 17/50

(52) U.S. Cl. 703/15

(57) ABSTRACT

The present disclosure provides a method and apparatus for using frequency domain loss functions, such as Impedance, Z, or Admittance, Y, parameters, in a time-based simulator. The Z or Y parameters are either calculated by an electromagnetic field solver, or are empirically measured, at selected frequencies. Preferably, the selected frequencies are related to one another by a logarithmic scale, providing for the determination of a finite series transfer function of the system which is accurate across a very wide range of frequencies, from near zero Hertz, to frequencies on the order of a hundred Gigahertz. The transfer function preferably takes the form of a fitted series, with the residues of the series evaluated using the DREF technique. In addition, the resulting residues are used to realize circuit loss networks which are incorporated into the modeled circuit and are used in time or frequency domain simulators to accurately simulate losses associated with the transmission of test signals in the modeled lossy circuit. This disclosure provides for circuit modeling and simulation which is accurate across a wide frequency range, which is stable for transfer functions of high order, and which is quickly and efficiently performed for large circuits.

### REFERENCE TO OTHER APPLICATIONS

This patent application claims priority from U.S. Provisional Patent application Serial No. 60/281,572 filed Apr. 5, 2001, of the same title and inventor.

### BACKGROUND OF THE INVENTION

The present disclosure relates to circuit simulation; in particular, it provides an improved system for quickly extracting and using frequency domain system data for use in time-based simulation.

As electronic circuit design has become increasing complicated, expensive and time consuming, computer-based circuit simulation has gained importance as a means of reliably testing designs of large circuits. Typically, a large circuit represents an aggregation of thousands of components, and it is difficult during the design stage of the circuit to predict how these components will influence one another during circuit operation.

This design problem is further enhanced when effects of other, external components are considered along with a sub-circuit being modeled. For example, when effects of adjacent high frequency transmission paths or surface mounts of an integrated circuit are considered together with the design of the integrated circuit, the resulting system model may be quite different than was the case for the integrated circuit alone. Moreover, as components are called upon to operate at faster and faster speeds, driven in large part by the speed of operation of newer digital systems, analysis of transient and high frequency conditions becomes increasingly critical to circuit reliability.

It is frequently desired to test large circuit designs before circuit prototypes are actually built, since prototype fabrication may be costly and time consuming; computer simulation of mathematical models only of the circuit design, before prototype fabrication, can lead to quick design changes while saving many thousands of dollars associated with such fabrication.

To this end, circuit simulation is frequently performed by software which operates on a mathematical model of a large circuit. A mathematical model of a circuit is frequently used, even if a circuit prototype is actually available, since high speed computers can quickly and efficiently predict circuit response at many different measurement points within the circuit, for example, at the ports of an integrated circuit, for many different input signal conditions. For large circuit designs, manual simulation can sometimes take far more time that computer-based simulation. The accuracy and speed of the computer-based models are very dependent upon the simulation tools used.

Many common computer simulators are variations of an early simulator tool, “SPICE,” (which stands for “simulation program with integrated circuit emphasis”). These programs typically operate by accepting circuit frequency response parameters, either directly from a computer aided design (“CAD”) package, a simulator (using discrete frequencies to directly measure frequency response of a circuit prototype), or another means. The simulator is then used to simulate special signal conditions for the circuit which are usually not discrete frequencies, i.e., to predict transient responses and the like. The computer-based simulators typically use numbers which represent test input signals, e.g., initial voltages, currents and frequencies. The simulators usually conduct a time-based analysis of response to the input signal conditions at the different measurement points of the circuit.

Some simulators employing “direct convolution” operate directly on the frequency response parameters by multiplying them with input test signals which have been converted to the frequency domain (including both instantaneous inputs as well as historical inputs, to thereby account for time-delays within the circuit). By properly selecting test frequencies, one obtains information to predict an entire range of operation of a digital device (commonly extending from near zero hertz to several gigahertz).

Ideally, a set of frequency responses provides a complete set of information from which to model circuit performance for any given input frequency or condition. This information is then processed to determine the frequency response parameters that generally are in the form of an impedance matrix or an admittance matrix; it is also sometimes desired to use a “scattering” matrix or scattering parameters. Scattering parameters (or “S-parameters”) may be preferred, as the S-parameters of passive devices will always have an absolute value less than 1, thus dramatically increasing the stability of typical analysis based upon them.

The computer-based simulator may then operate by using an Inverse Fast Fourier Transform (“IFFT”) to convert the parameters to the time domain, and by applying time-intensive direct convolution of the time domain parameters to the test input signals of interest, to yield predicted circuit behavior. Unfortunately, use of the IFFT requires that the frequency response parameters represent evenly spaced frequencies, e.g., 0, 5, 10, 15 kilohertz, etcetera.

U.S. Pat. No. 5,946,482 to Barford et al. and U.S. Pat. No. 5,610,833 to Chang et al., and incorporated by reference, describes the use of such simulation methods and note difficulties when analyzing circuits over wide frequency ranges, yet desiring high frequency resolution.

Additional problems with SPICE simulations prior to the present invention are in poor accuracy as to transmission losses, particularly for simulations of high frequency. For example, SPICE simulations of data network cable systems may underestimate transmission losses by an order of magnitude or greater when the simulation is used to predict losses at frequencies greater than 1 gigahertz. Fortunately for semiconductor chip design these losses are not significant due to small conductor lengths. However, such losses become important for interconnection between components such as in computer backplanes and interconnections between devices such as data networks between computers.

Some simulators have attempted to improve simulation of transmission losses by the use of proprietary modeling techniques. An example of such an approach is available from Avanti Corporation and is referred to as “W element” analysis. Such proprietary approaches limit the users ability to use familiar SPICE modeling simulators as well as reducing efficiency of the simulation process. Furthermore, while the use of W elements is an improvement over other simulations, it still provides low accuracy as compared to the present invention.

As a result, there is needed an improved method and system for circuit simulation that provides high levels of accuracy and accounts for transmission losses and effects, particularly at high frequencies. Ideally, such a system and method should be in form where it can be integrated with relatively minor deviation from typical simulator programs, such as “SPICE,” such that the system can directly operate on standard simulator inputs. The present invention solves these needs and provides further, related advantages.

### BRIEF SUMMARY OF THE INVENTION

The present invention provides for time-based simulation of a circuit design using frequency domain data. More particularly, the present invention utilizes Derivative Residue Estimation Functions (“DREF”) to model network transmission losses to system parameters, thereby fitting a transfer function which is highly accurate across a range of from near zero hertz to a hundred or more gigahertz.

More particularly, the invention provides a method of improving SPICE electronic circuit simulations by providing an improved lossy transmission sub-circuit model to SPICE users. In one embodiment of the model, RL elements are partitioned out over the length of the sub-circuit, with an RL element representing conductor losses at selected frequencies, preferably one or more frequencies for each frequency decade. In another embodiment of the present invention, RC elements are used to represent dielectric losses for at selected frequencies, preferably one or more frequencies for each frequency decade. The present invention allows accurate transmission simulations to be performed with all standard SPICE circuit simulators.

### BRIEF DESCRIPTION OF THE DRAWINGS

FIG. 1a—Resistance Losses simulation for a 50 Ohm 22 AWG coaxial cable 0.5 meters long in accordance with one embodiment of the present invention;

FIG. 1b—Resistance and dielectric losses simulation for a 50 Ohm 22 AWG coaxial cable 0.5 meters long having a dielectric loss tangent of 0.01, in accordance with one embodiment of the present invention;

FIG. 2—Description of Cauer network solutions

FIG. 3—Derivation of RL network derivative residue estimation function

FIG. 4—Derivation of RC network derivative residue estimation function

### DETAILED DESCRIPTION OF THE INVENTION

The invention summarized above and defined by the enumerated claims may be better understood by referring to the following detailed description, which should be read in conjunction with the accompanying drawings. The particular example set out below is the preferred implementation of a system that identifies parameters for simulation using frequency domain data, and which then applies derivative residue estimation functions to determine SPICE sub-circuits to perform accurate circuit or transmission line simulation

The preferred embodiment is a system for creating SPICE sub-circuits representing frequency domain response for transmission elements of an electronic circuit being simulated. The preferred embodiment improves the accuracy of the simulation as compared to actual behavior of circuit transmission elements. Ideally, the principles taught herein may be applied to conventional simulator designs based on “SPICE,” such that the preferred embodiment consists of code (firmware or software) which controls a machine (a computer's CPU) to obtain the frequency or time domain data performance simulation based on that data.

The preferred embodiment is designed to perform the following tasks, as will be elaborated upon below. First, frequencies at which circuit response will be sampled must be selected; these frequencies will be referred to herein as “test frequencies,” and are chosen such that a transfer function can be estimated in a manner that it is accurate for all regions of interest, e.g., all applicable forms of transient response over the desired frequency ranges.

Second, transmission elements and their related parameters are determined for the system. These parameters are determined by measuring frequency response of the element, or in the alternative, determined from traditional simulations performed by numerical electromagnetic field solvers of the circuit or transmission line elements.

Third, sub-circuit models are provided from a determination of the residues using the DREF technique for each circuit transmission element. Typically two sub-circuit models are provided: skin effect conductor loss model (RL model) and transmission dielectric loss model (RC model).

Fourth, the transmission element sub-circuit models are entered into a “SPICE” simulator which computes the simulation for the resultant complete circuit. Such simulators are known in the art and are available from numerous sources including for example, Hewlett Packard, Avanti Corporation and others. The resultant circuit model has been found to accurately portray circuit behavior throughout the range of testing frequencies.

Selection of Test Frequencies

The test frequencies are selected over the range from the lower corner frequency up to the maximum frequency, as selected by the user. Intervening test frequencies are chosen at convenient intervals. For increased accuracy, greater numbers of intervening frequencies are chosen. It has been found that selecting intervening frequencies with one frequency chosen at each decade provides adequate accuracy for most purposes.

It is not necessary to test or determine the parameters at frequencies below the lower corner frequencies because in the technique used here the loss parameter at these lower frequencies correspond to the DC values. At such lower frequencies, the DC value (frequency of 0 hertz) is used.

In the case of determining the conductor loss model, the lower corner frequency is selected as the lower of the frequency calculated from the geometry of the transmission element conductor (Equation 1a) and the frequency calculated from the maximum frequency and resistance per unit length (Equation 1b).

$$\text{Equation 1a:}$$

$${F}_{o , c} = \frac{{R}_{0} * {U}^{2}}{π * {μ}_{o} * A}$$

F_{o,c}=(R₀/Rₘ)²*Fₘ Equation 1b:

wherein F_{o,c} is the lower corner frequency; Fₘ is the user selected maximum frequency, R₀ is the conductor DC resistance per unit length; Rₘ is the conductor resistance per unit length at the user selected maximum frequency; U is the conductor circumference; A is the conductor cross sectional area and μₒ is the permeability of free space.

In the case of determining the dielectric loss model, the lower corner frequency is calculated from the transmission characteristics and cross-section in accordance with Equation 2:

$$\text{Equation 2:}$$

$${F}_{o , d} = \frac{1}{2 * π * L * τ}$$

wherein F_{o,d} is the lower corner frequency; L is the transmission line cross-section length and τ is the section time delay per unit length.

As previously discussed, intervening frequencies are then chosen between the lower corner frequencies and the user selected maximum frequency, for example, with one frequency selected for each frequency decade.

Determination of Frequency Response Parameters and Residues

The selected test frequencies are used to discretely obtain samples of performance of the circuit transmission element under study across a range of frequencies. Generally, measurements will be made at the ports of the device under study (e.g., an integrated circuit). From these responses, given the signal used to produce the response, frequency response parameters are calculated which describe circuit response to the test signals at the test frequency used. Typically, these parameters will be related to admittance or impedance in some manner.

The frequency response of the circuit of interest (and the S-parameters calculated therefrom) is obtained in one of several ways. One method of obtaining S-parameters is to utilize a physical measurement tool, typically a network analyzer (such as the “HP8510” or “HP4396” series network analyzers, made by Hewlett-Packard Company), which measures circuit response and automatically calculates S-parameters, providing them as a digital output.

Another method of obtaining the frequency response parameters is performing an AC analysis with an electromagnetic field simulator, for example a SPICE simulator. Sometimes other computer based methods are available, for example, certain computer aided design (“CAD”) formats, S-parameters can sometimes be computed directly from these design details using appropriate CAD tools.

Creating Sub-Circuit Models

Once frequency response parameters have been measured, or otherwise determined, transmission element sub-circuit models are created. Separate sub-circuit models are created for conductor losses and dielectric losses. Users select whether conductor loss model, dielectric loss model, or both models are to be entered into the eventual SPICE simulation.

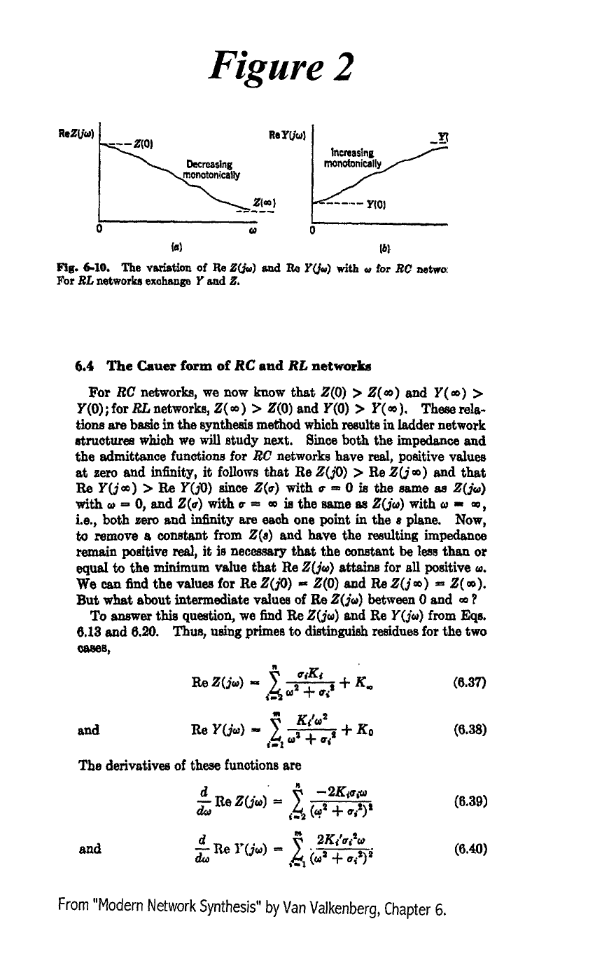

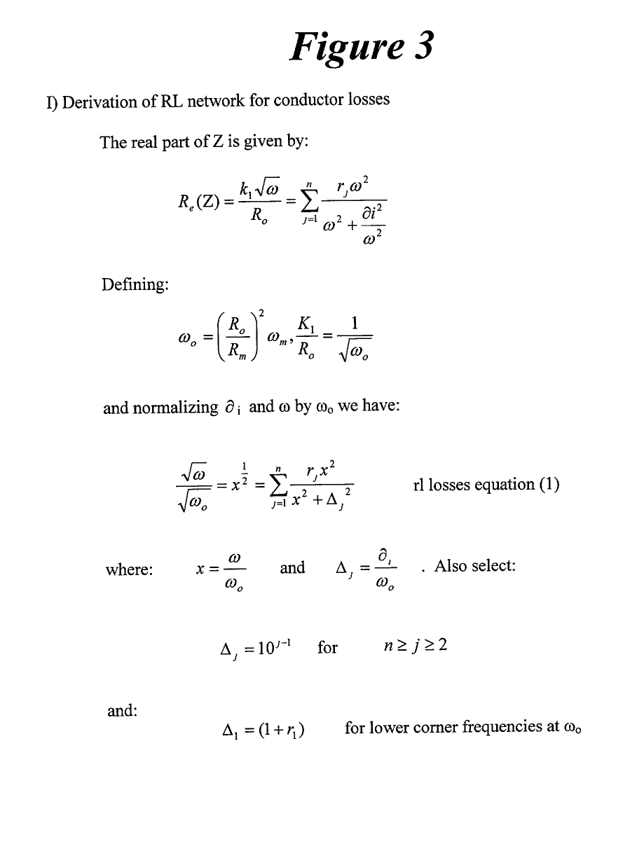

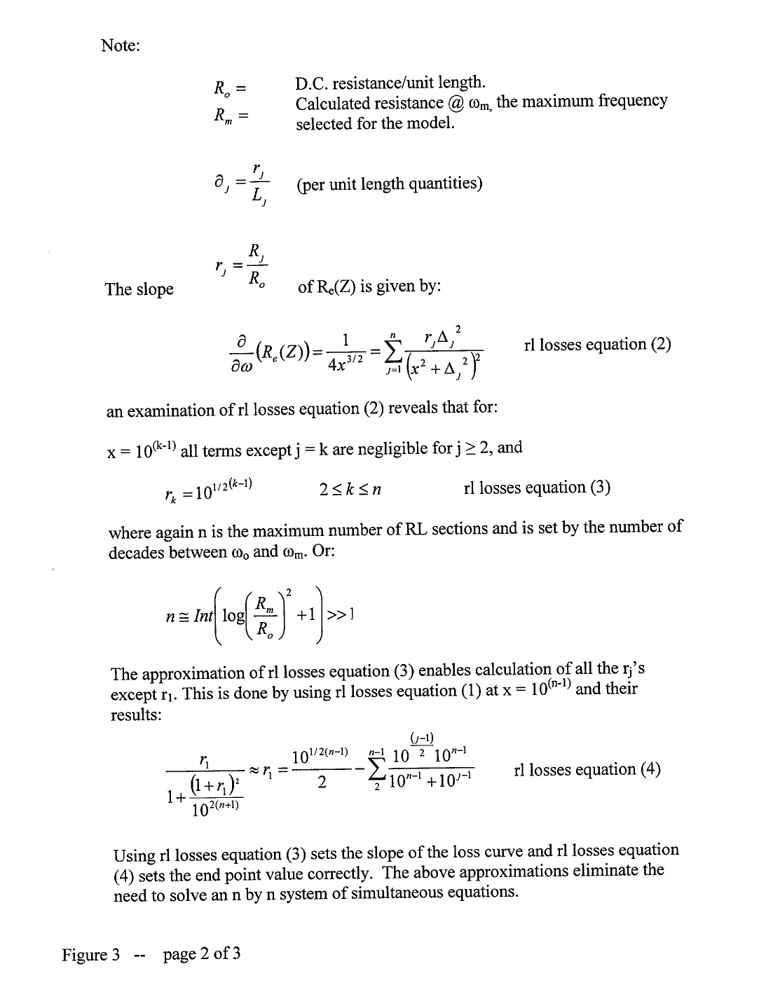

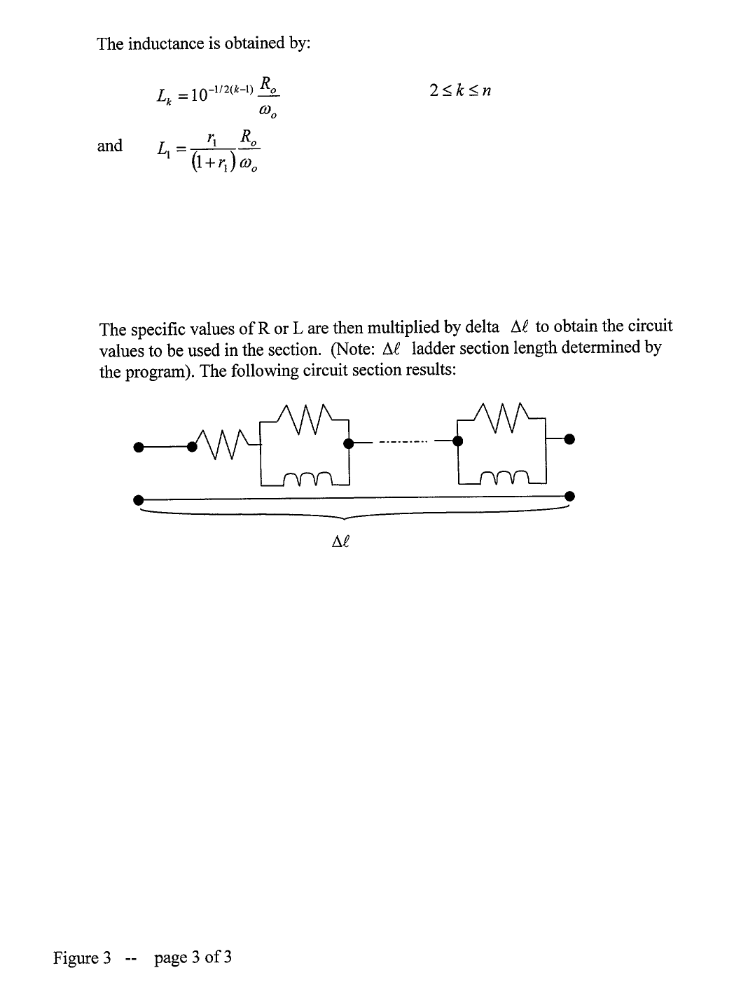

Sub-circuit modeling is based upon Cauer network functions where the residues of the resulting series expansion are found using the DREF technique. In the case of the conductor loss models, the real part of the skin effect conductor losses impedance function is represented by a series of network elements, each comprising a parallel resistance-inductor pair. Derivation of the mathematical functions for the conductor loss models are provided in FIG. 2 and FIG. 3.

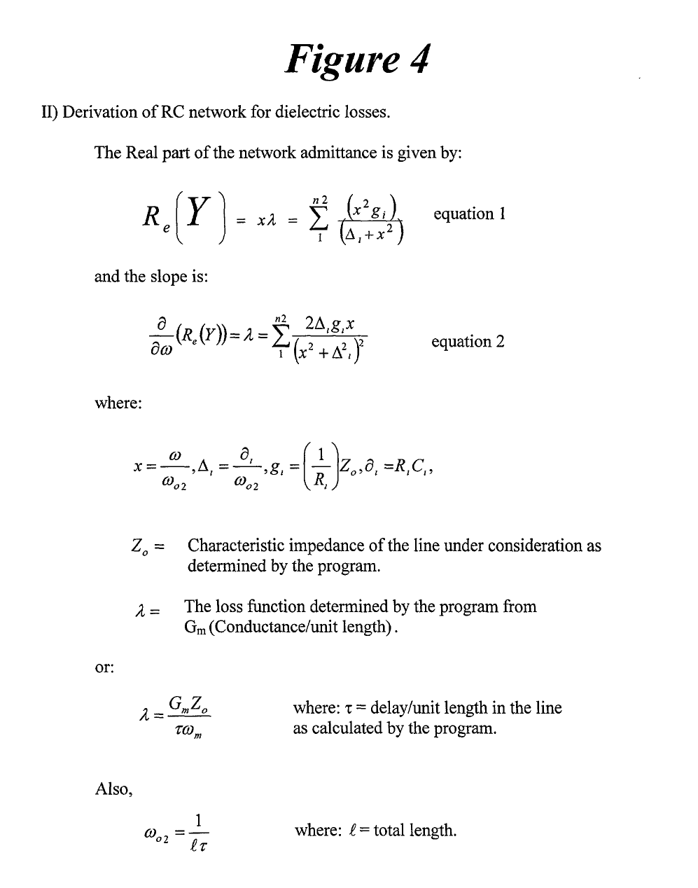

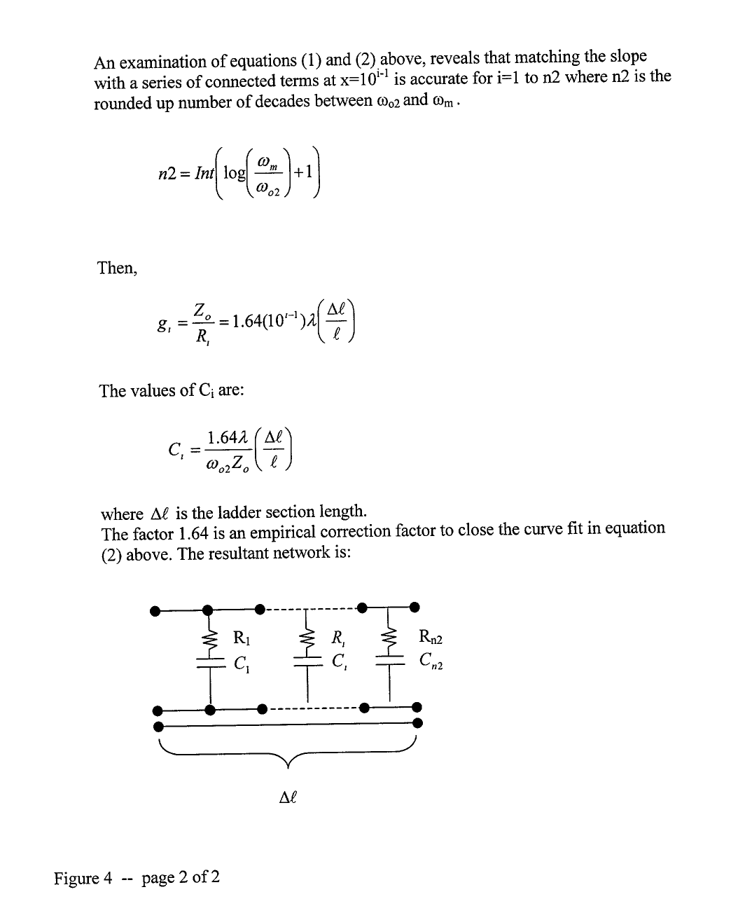

Similarly, sub-circuit modeling for the real part of the dielectric losses admittance function is also represented by a series expansion of residue functions. In contrast to the conductor loss model, the dielectric loss model comprises a parallel combination of network elements, each comprising a series resistance-capacitance pair. Derivation of the mathematical functions for the dielectric loss models are provided in FIG. 2 and FIG. 4.

The Derivative Residue Estimation Function, or DREF, technique uses the derivatives of the impedance or admittance functions, as appropriate, at the test frequencies, to evaluate the residues. With this technique, the most significant residue term of the series is that corresponding to the test frequency. The lowest order residue of the impedance or admittance function is evaluated at the maximum frequency. This insures that the series of network functions fits the impedance or admittance functions in both slope and magnitude.

Ideally, both conductor loss models and dielectric models are incorporated into the resultant SPICE simulation, although this is not always necessary. For example, if a user is only interested in conductor losses then the dielectric loss model elements may be omitted. Conversely, if a user limits the circuit to only dielectric losses, then the conductor loss model elements may be omitted.

Simulation

Once suitable loss sub-circuit models are developed for the transmission elements of the electronic circuit under study, they are added to the SPICE net list input deck or file. Circuit simulation and analyses are then run in the usual fashion for that version of the SPICE simulator.

### EXAMPLE

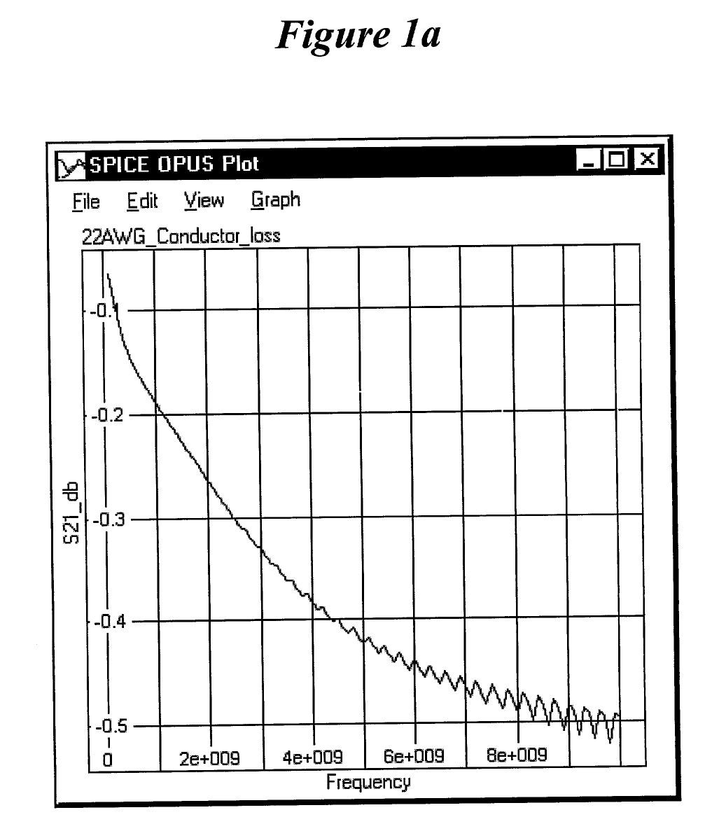

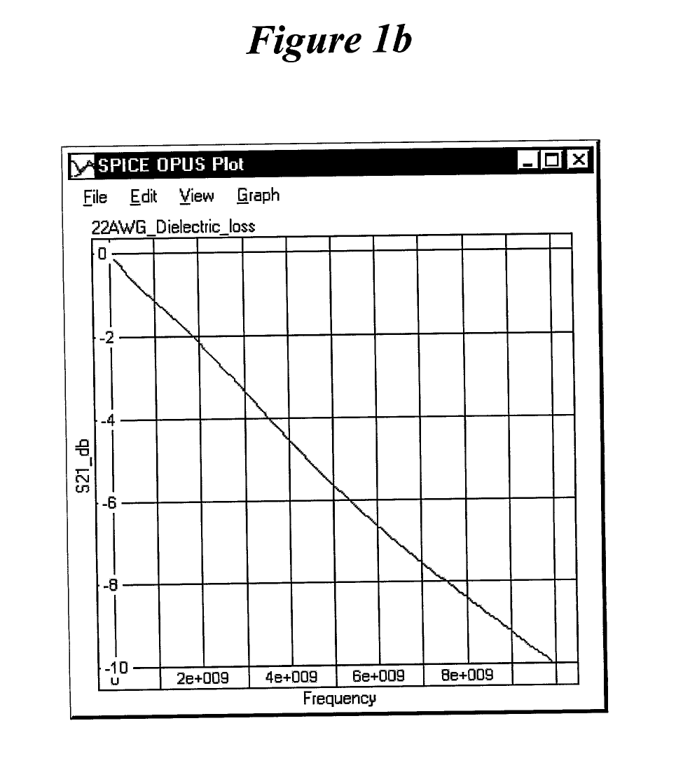

An example of the use of the present invention is illustrated in FIGS. 1a and 1b. A transmission circuit element consisting of a 0.5 meter length of 22 AWG copper coaxial cable having a dielectric loss tangent of 0.01 was used as the circuit element of interest.

A maximum frequency of 10 Gigahertz was selected. Equation 1b resulted in a F_{o,c} of 1.982 Megahertz. The known geometry and materials with specified loss properties were numerically solved for the transmission and loss parameters of the coaxial cable as utilized in Equation 1b and Equation 2.

In similar fashion, Equation 2 determined a Fo,d, dielectric lower corner frequency, of 299 Megahertz based upon the transmission parameters for the coaxial cable. Plots of the conductor losses alone and conductor loss plus dielectric losses are illustrated in FIGS. 1a and 1b.

The resultant conductor loss sub-circuit model is represented as:

.SUBCKT TYPEL 1 9

RDC_{—}1 1 2 3.80643e-005

R1_{—}1 2 3 0.000311819

L1_{—}1 2 3 4.21561e-016

R2_{—}1 3 4 0.00012037

L2_{—}1 3 4 6.07292e-012

R3_{—}1 4 5 0.000380643

L3_{—}1 4 5 1.92043e-012

R4_{—}1 5 6 0.0012037

L4_{—}1 5 6 6.07292e-013

R5_{—}1 6 7 0.00380643

L5_{—}1 6 7 1.92043e-013

XL 7 9 INDUCT

The sub-circuit element “INDUCT” has the usual SPICE meaning and represents the series element of a lossless cable ladder network, as applied to the conductor simulated. The resultant conductor loss network can also be imbedded into a lossless modal model with appropriate parsing of the loss network over the length of the circuit.

The resultant transmission dielectric sub-circuit model which is a part of the above sub-circuit TYPEL, is represented as:

.SUBCKT TYPEL 1 9

RT1_{—}1 9 10 3054.85e6

CT1_{—}10 0 1.04192e-015

RT2_{—}1 9 11 305.485e6

CT2_{—}1 11 0 1.04192e-015

RT3_{—}1 9 12 30.5485e6

CT3_{—}1 12 0 1.04192e-015

XC 9 CAPAC

The sub-circuit element “CAPAC” has the usual SPICE meaning and represents the shunt element of the lossless cable ladder network, as applied to the conductor simulated. Similarly to the transmission loss model, the resultant transmission dielectric network can also be imbedded into a lossless modal model with appropriate parsing of the loss network over the length of the circuit.

The conductor loss and transmission dielectric sub-circuit models can be used separately or combined into a single model that is entered into the SPICE simulation of the electronic circuit under study. Combination is accomplished by merely combining the textual representation of the models under a single sub-circuit title (“.SUBCKT TYPEL 1 9” in the above example).

Based on the resultant sub-circuit models, SPICE simulations were run and compared to simulations without the models of the present invention. It was determined that large errors occur when the sub-circuit models are not used.

What has been described is a method and apparatus for using frequency domain data to perform time-based simulation, a method and apparatus which may be fully retrofitted to existing “SPICE”-based programs by addition of sub-circuit models incorporating “derivative residue estimates” calculated in accordance with FIG. 3 and FIG. 4. Having thus described an embodiment of the invention, it will be apparent to those skilled in the art that other equivalent forms of the present invention are possible. For example, the use of additional test frequencies in order to attain higher accuracy or the added use of W parameters with the present invention are envisioned. Such equivalent forms, though not expressly described or mentioned above, are nonetheless intended and implied to be within the spirit and scope of the invention. Accordingly, the foregoing discussion is intended to be illustrative only; the invention is limited and defined only by the various following claims and equivalents thereto.

What is claimed is:

1. A method of using parameters to simulate an electronic circuit having one or more conductor loss elements and one or more dielectric loss elements, said method utilizing a digital processor and comprising:
selecting a plurality of test frequencies with which to measure or simulate the frequency response of the electronic circuit;
wherein said test frequencies comprise a lower corner frequency, a maximum frequency and one or more intervening test frequencies
determining parameters for the circuit that describe frequency response of each conductor loss element and each dielectric loss element, for each of the test frequencies;
determining using the digital processor to, for each conductor loss element, a Derivative Residue Estimation Function;
determining using the digital processor to, for each dielectric loss element, a Derivative Residue Estimation Function;
determining using the digital processor to, a sub-circuit model for each Derivative Residue Estimation Function, wherein said sub-circuit model provides parameters that when entered into a electronic circuit simulator describe the behavior of its respective loss element;
entering sub-circuit models into an electronic circuit simulator and
simulating the circuit using the electronic circuit simulator.

2. The method of claim [c1] wherein intervening test frequencies are selected at each frequency decade.

3. A method of using parameters to simulate an electronic circuit having one or more conductor loss elements, said method utilizing a digital processor and comprising:
selecting a plurality of test frequencies with which to measure or simulate the frequency response of the electronic circuit;
wherein said test frequencies comprise a lower corner frequency, a maximum frequency and one or more intervening test frequencies
determining parameters for the circuit that describe frequency response of each conductor loss element and each dielectric loss element, for each of the test frequencies;
determining using the digital processor to, for each conductor loss element, a Derivative Residue Estimation Function;
determining using the digital processor to, a sub-circuit model for each Derivative Residue Estimation Function, wherein said sub-circuit model provides parameters that when entered into a electronic circuit simulator describe the behavior of its respective loss element,
entering sub-circuit models into an electronic circuit simulator and
simulating the circuit using the electronic circuit simulator.

4. The method of claim [c3] wherein intervening test frequencies are selected at each frequency decade.

5. A method of using parameters to simulate an electronic circuit having one or more dielectric loss elements, said method utilizing a digital processor and comprising:
selecting a plurality of test frequencies with which to measure or simulate the frequency response of the electronic circuit;
wherein said test frequencies comprise a lower corner frequency, a maximum frequency and one or more intervening test frequencies
determining parameters for the circuit that describe frequency response of each conductor loss element and each dielectric loss element, for each of the test frequencies;
determining using the digital processor to, for each dielectric loss element, a Derivative Residue Estimation Function;
determining using the digital processor to, a sub-circuit model for each Derivative Residue Estimation Function, wherein said sub-circuit model provides parameters that when entered into a electronic circuit simulator describe the behavior of its respective loss element;
entering sub-circuit models into an electronic circuit simulator and
simulating the circuit using the electronic circuit simulator.

6. The method of claim [c5] wherein intervening test frequencies are selected at each frequency decade.
